(19) United States
(12) Patent Application Publication
(10) Pub. No.: US 2003/0112145 A1
(43) Pub. Date: Jun. 19, 2003

(54) Thermoelectric fire alarm device

(76) Inventors: Daniel T. Allen, San Diego, CA (US); John C. Bass, La Jolla, CA (US)

Correspondence Address: John R. Ross, III, Ross Patent Law Office, P.O. Box 2138, Del Mar, CA, 92014, US

(21) Appl. No.: 10/025,129

(22) Filed: Dec. 18, 2001

(51) Int. Cl. G08B 17/00

(52) U.S. Cl. 340/584

(57) ABSTRACT

A thermoelectric fire alarm system capable of generating electric power. A thermoelectric device is compressed between a heat absorbing plate and a cold side heat sink. A fire heats the plate. A phase change material is provided to absorb heat at an approximately constant temperature to keep the cold side heat sink relatively cold to provide at least a temporary temperature differential across the thermoelectric device allowing the device to generate sufficient electric power to activate an alarm identifying the fire.

The present invention relates to thermoelectric devices and fire alarms. This invention was developed under a contract with the United States Government and the United States Government has certain rights in any patent resulting from this application.

### BACKGROUND OF THE INVENTION

Thermoelectric devices for generating electricity from temperature differentials are well known and have been available for many years. Such devices are described in U.S. Pat. Nos. 5,856,210 and 5,875,098 which are assigned to Applicant's employer and are incorporated herein by reference. Many fire alarm devices are available. These devices typically require a source of electric power and a battery typically supplies this power and the battery may be a rechargeable battery kept charged with a trickle charge from a utility power source. In many cases the utility source is not available to keep the battery charged and battery replacement may be difficult or the task may be forgotten. What is needed is a fire alarm that serves as its own electric power source.

### SUMMARY OF THE INVENTION

The present invention provides a thermoelectric fire alarm system capable of generating electric power. A thermoelectric device is compressed between a heat absorbing plate and a cold side heat sink. A fire heats the plate. A phase change material is provided to absorb heat at an approximately constant temperature to keep the cold side heat sink relatively cold to provide at least a temporary temperature differential across the thermoelectric device allowing the device to generate sufficient electric power to activate an alarm identifying the fire.

### BRIEF DESCRIPTION OF THE DRAWINGS

FIG. 1 is drawing of a preferred embodiment of a portion of the present invention. FIGS. 2, 3 and 4 are circuit diagrams of preferred alarm circuits.

### DETAILED DESCRIPTION OF PREFERRED EMBODIMENTS

### First Preferred Embodiment

A first preferred embodiment of the present invention can be described by reference to the drawings.

Fire Alarm Device

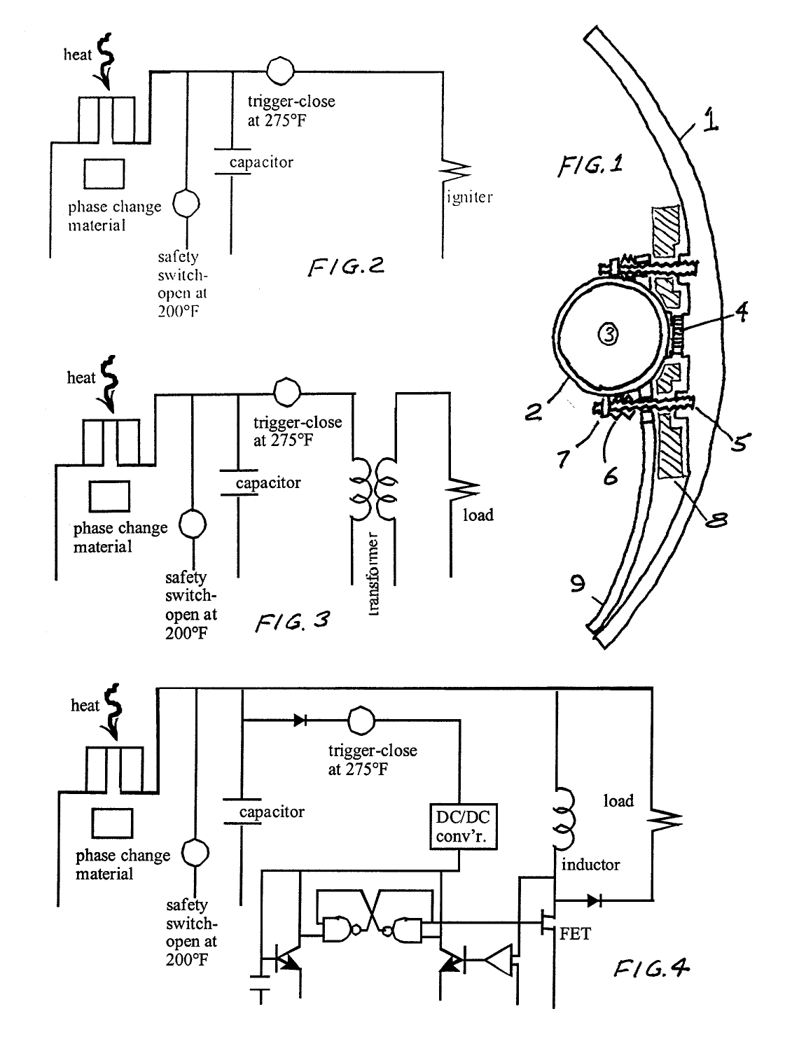

FIG. 1 is a drawing showing features of the first preferred embodiment of the present invention. A heat receiving plate 1 is positioned in a location that would be subject to heat from a potential fire. It is in this embodiment an aluminum plate having a surface area of about 250 cm² and about 3 mm thick. This will be the heat source in case of a fire. The cold heat sink is aluminum cylinder 2 having a 25 mm diameter and 28 mm length and an easily ruptured top which serves as a container for a phase change material. The phase change material in this embodiment is 23 grams of lithium nitrate trihydrate (LiNO3*3H2O) 3 sealed within cylinder 2. In this preferred embodiment the phase change is from solid to liquid. This amount of material will absorb 6,400 Joules of heat at a constant temperature of 80° C. as it melts. Mounted between the heat source 1 and the heat sink 2 is electric generating thermoelectric module 4. Preferably this module is thermoelectric module having 242 couples (an array of 22×22 thermoelectric elements, each 0.4 mm on a side and 2 mm thick, available from HiZ Technologies, Inc. with offices in San Diego, Calif. Techniques for making modules of this type are described in the patents referred to above. The preferred module produces about 0.75 milli-Watts at 4.5 Volts given a temperature difference of about 60° C. The thermoelectric module is held is tight compression with four threaded studs 5, with Belleville washer springs 6 and nuts 7. Thermal insulating blanket material such as Aerogel available from Aspen Systems with offices in Marlborough, Massachusetts is placed around the module to prevent heat from bypassing the heat thermoelectric module to heat sink 2. In case of fire plate 1 will get very hot. Some heat will pass through module 4 to heat sink 2-3. The LNT will remain at about 80 degrees until all of the LNT has melted. Applicant estimates that in the interval required for the 23 grams of LNT to evaporate the module 4 will generate about Watt-seconds of energy. This is sufficient energy to operate a properly designed alarm device or it could provide electric energy to operate other devices such as controls for a sprinkler system. This energy could power a cell phone programmed to call 911 or the fire department.

Electric Circuits

Preferred electric circuits are shown in FIGS. 2, 3 and 4. In the FIG. 2 drawing, the thermoelectric module is grounded through heat actuated safety switch 8 until the switch is heated to a temperature of about 200° F. This avoids false alarms that might be caused by normal temperature swings generating small amounts of power in module 4. If some transient event causes the device to be heated slightly above 80° C. the LNT will melt but the triggering temperature will not be reached, there will be no alarm and the LNT will later refreeze when the temperature drops and the device will remain ready. A hot fire will produce a temperature difference on the two sides of module 4 of several hundred degrees F during the period it takes the LNT to melt. During this time module is producing a total of about 2 J of electric power at 13.5 Volts which is stored on capacitor 10 at the same voltage. Trigger switch 12 closes at a preset temperature of about 275° C. which permits the two Joules of electric power to be applied to an alarm device 14 to warn of a potential fire. The specific design of the circuit shown in FIG. 2 can be made to fit the application. For time, t, after the triggering of the circuit, the current, I, and the cumulative energy released, U, are as follows, where E₀ is the stored voltage.

$$V ( t ) = {E}_{0} {ⅇ}^{- \frac{t}{R C}} , I ( t ) = \frac{V ( t )}{R} , U = \int V ( t ) I ( t ) ⅆ t = \int {\frac{{E}_{0}^{2}}{R} [ {ⅇ}^{- \frac{t}{R C}} ]}^{2} ⅆ t$$

FIG. 3 shows modified version of FIG. 2. In this case a transformer has been added which permits the voltage from module 4 to be increase or decreased for specific applications by choice of the various electrical components shown.

The FIG. 4 circuit is a complex appearing circuit in which the inductor is in series with a standard power field effect transistor. The trigger sends power to a conventional bi-stable circuit that “closes” the FET. It then monitors the voltage between the inductor and the FET, and at a certain predetermined value of that voltage, which would correspond to a significant predetermined value of that voltage, which would correspond to a significant current flow through the inductor, it shuts the FET. The effect of that is to put a high voltage pulse into the load.

While the above description contains many specificites, the reader should not construe these as limitations on the scope of the invention, but merely as exemplifications of preferred embodiments thereof. Those skilled in the art will envision many other possible variations within its scope. For example, there are many other ways to make the connections between the legs other than the methods discussed. Many other module designs could be used. The device could be adapted to energize any one of many electric circuits similar to the ones given as examples. Accordingly, the reader is requested to determine the scope of the invention by the appended claims and their legal equivalents, and not by the examples which have been given.

We claim:

1. A thermoelectric fire alarm system comprised of:
A) a heat receiving plate comprised of a material capable of high temperature operation,
B) a cold unit comprising a container containing a phase change material which undergoes a phase change at a predetermined temperature,
C) a thermoelectric module compressed between said plate and said cold unit, said module having a plurality of p-legs and a plurality of n-legs, said p-legs and said n-legs being electrically connected to produce from said thermoelectric module electric power at a desired voltage resulting from the temperature difference between said plate and said unit, and
D) an electric circuit comprising an electric storage device, and alarm and a trigger switch for discharging said electric storage device in order to activate the alarm.

2. A thermoelectric alarm system as in claim 1 wherein said material capable of high temperature application is aluminum.

3. A thermoelectric alarm system as in claim 1 wherein said phase change material in lithium nitrate trihyrate.

4. A thermoelectric alarm system as in claim 1 wherein said phase change material is benzil.

5. A thermoelectric alarm system as in claim 1 wherein said phase change material is Cerroshield.

6. A thermoelectric alarm system as in claim 1 wherein said phase change material is a wax.

7. A thermoelectric alarm system as in claim 6 wherein said wax is Elvax 3130.

8. A thermoelectric alarm system as in claim 1 and further comprising a compression system for holding said module in between said heat receiving plate and said cold unit.

9. A thermoelectric alarm system as in claim 1 and further comprising a thermal insulating blanked material.

10. A thermoelectric alarm system as in claim 1 wherein said electric storage device is a capacitor.

11. A thermoelectric alarm system as in claim 1 wherein said electric storage device is a battery.
